(19) United States
(12) Patent Application Publication
(10) Pub. No.: US 2019/0108689 A1
(43) Pub. Date: Apr. 11, 2019

(54) PRECEDENCE PATH MANAGEMENT SYSTEM, MANAGEMENT METHOD AND STORAGE MEDIUM STORING MANAGEMENT PROGRAM

(71) Applicant: NEC CORPORATION, Tokyo (JP)

(72) Inventors: Itaru NISHIOKA, Tokyo (JP); Kenichi YAMASAKI, Tokyo (JP); Keiji HARUTA, Tokyo (JP); Ryusuke UEDA, Toyko (JP); Shinya MIZUTA, Tokyo (JP)

(73) Assignee: NEC CORPORATION, Tokyo (JP)

(21) Appl. No.: 15/745,282

(22) PCT Filed: Mar. 29, 2017
(86) PCT No.: PCT/JP2017/012971

§ 371 Date: Jan. 16, 2018

(51) Int. Cl. G07B 15/02

(52) U.S. Cl. CPC G07B 15/02; G08G 1/14

(57) ABSTRACT

A precedence pass management system that is communicable with a user terminal and an information terminal that presents in a facility within a congested area, the precedence pass management system includes an issuing unit and a determination unit. The user terminal acquires parking information indicating a use of a parking area outside the congested area and transmits the parking information to the precedence pass management system, the issuing unit receives the parking information from the user terminal, issues a precedence pass for prioritizing an order of a user of the parking area to a queue in the facility, based on the parking information, and associates the precedence pass with the parking information to be stored in storage, the determination unit receives a use request of the precedence pass including parking information from the information terminal, collates the parking information stored in the storage with the parking information included in the use request to determine whether the precedence pass is usable, and transmits a determination result as to whether the precedence pass is usable to the information terminal. The information terminal receives the determination result from the precedence pass management system and controls output unit of the information terminal in response to the determination result.

### TECHNICAL FIELD

The disclosed subject matter relates to a precedence pass management system or the like which is used for Park & Ride.

### BACKGROUND ART

There is a scheme called Park & Ride which stops a vehicle from a destination to a distant parking area (Park) and uses a public transport facility such as a railway train (Ride) to suppress an influx of the vehicles into the city. In order to promote use of Park & Ride, measures are taken to discount usage fees of a parking area, a public transport, a rental cycle or the like for users of the parking area relating to Park & Ride.

For example, PTL 1 discloses a Park & Ride system for determining a parking fee in response to a traffic density of a road to the destination.

### CITATION LIST

### Patent Literature

[PTL1] Japanese Unexamined Patent Application Publication No. 2004-199571

### SUMMARY OF INVENTION

### Technical Problem

Incentive targeting money is not enough to promote the use of Park & Ride. For example, when moving from a home to the parking area in tourist spot by the vehicle without Park & Ride, it is assumed that round-trip transportation expenses including a parking fee and fuel cost will cost 5000 yen.

On the other hand, when moving to the tourist spot via the public transport using Park & Ride, it is assumed that travel costs including the discounted parking fee and public transportation fee, and the fuel cost are 4500 yen. In this case, a movement becomes complicated with respect to a discount amount, and a cost-effectiveness using Park & Ride is small. Therefore, one is highly unlikely to lead a motivation for parking the vehicle in the way from the home to the tourist spot.

An object of the disclosed subject matter is to provide a precedence pass management system or the like which gives a new incentive, separately from the money, to a user of the parking area relating to Park & Ride and enables promotion of use of Park & Ride.

### Solution to Problem

One aspect of a precedence pass management system of the disclosed subject matter is a precedence pass management system that is communicable with a user terminal and an information terminal that presents in a facility within a congested area. The precedence pass management system includes an issuing means and a determination means. The user terminal acquires parking information indicating a use of a parking area outside the congested area and transmits the parking information to the precedence pass management system. The issuing means receives the parking information from the user terminal, issues a precedence pass for prioritizing an order of a user of the parking area to a queue in the facility, based on the parking information, and associates the precedence pass with the parking information to be stored in storage means. The determination means receives a use request of the precedence pass including parking information from the information terminal, collates the parking information stored in the storage means with the parking information included in the use request to determine whether the precedence pass is usable, and transmits a determination result as to whether the precedence pass is usable to the information terminal. The information terminal receives the determination result from the precedence pass management system and controls output means of the information terminal in response to the determination result.

One aspect of the precedence pass management system of the disclosed subject matter is a precedence pass management system that is communicable with a parking terminal that presents in a parking area outside a congested area and an information terminal that presents in a facility within the congested area. The precedence pass management system includes an issuing means and a determination means. The issuing means receives parking information indicating a use of the parking area from the parking terminal, issues a precedence pass for prioritizing an order of a user of the parking area to a queue in the facility, based on the parking information, and associates the precedence pass with the parking information to be stored in storage means. The determination means receives a use request of the precedence pass including parking information from the information terminal, collates the parking information stored in the storage means with the parking information included in the use request to determine whether the precedence pass is usable, and transmits a determination result as to whether the precedence pass is usable to the information terminal. The information terminal receives the determination result from the precedence pass management system, and controls output means of the information terminal in response to the determination result.

One aspect of a management method of the disclosed subject matter is a management method of a precedence pass management system. The precedence pass management system is communicable with a user terminal and an information terminal that presents in a facility within a congested area. The user terminal receives parking information indicating a use of a parking area outside the congested area and transmits the parking information to the precedence pass management system. The precedence pass management system receives the parking information from the user terminal to a queue in the facility, based on the parking information, issues a precedence pass for prioritizing an order of a user of the parking area, and associates the precedence pass with the parking information to be stored in storage means, receives a use request of the precedence pass including parking information from the information terminal, collates parking information stored in the storage means with parking information included in the use request to determine whether the precedence pass is usable, and transmits a determination result as to whether the precedence pass is usable to the information terminal. The information terminal receives the determination result from the precedence pass management system and controls output means of the information terminal in response to the determination result.

One aspect of a management method of the disclosed subject matter is a management method of a precedence pass management system. A management method for a precedence pass management system that is communicable with a user terminal and an information terminal that presents in a facility within a congested area. The user terminal receives parking information indicating a use of a parking area outside the congested area and transmits the parking information to the precedence pass management system. The precedence pass management system receives the parking information from the user terminal to a queue in the facility, based on the parking information, issues a precedence pass for prioritizing an order of a user of the parking area, and associates the precedence pass with the parking information to be stored in storage means, receives a use request of the precedence pass including parking information from the information terminal, collates parking information stored in the storage means with parking information included in the use request to determine whether the precedence pass is usable, and transmits a determination result as to whether the precedence pass is usable to the information terminal. The information terminal receives the determination result from the precedence pass management system and controls output means of the information terminal in response to the determination result.

One aspect of a storage medium of the disclosed subject matter is a storage medium storing a management program for a precedence pass management system. The precedence pass management system is communicable with a user terminal and an information terminal that presents in a facility within a congested area. The user terminal acquires parking information indicating a use of a parking area outside a congested area and transmits the parking information to the precedence pass management system. The management program causes a computer to execute: receiving, from the user terminal, the parking information; based on the parking information, issuing a precedence pass for prioritizing an order of a user of the parking area to a queue in the facility, and associating the precedence pass with the parking information to be stored in storage means; receiving a use request of the precedence pass including parking information from the information terminal; collating parking information stored in the storage means with parking information included in the use request to determine whether the precedence pass is usable; and transmitting a determination result as to whether the precedence pass is usable to the information terminal. The information terminal receives the determination result from the precedence pass management system and controls output means of the information terminal in response to the determination result.

One aspect of a storage medium of the disclosed subject matter is a storage medium storing a management program for a precedence pass management system. The precedence pass management system is communicable with a parking terminal that presents in a parking area outside a congested area and an information terminal that presents in a facility within the congested area. The management program causes a computer to execute: receiving parking information indicating a use of the parking area from the parking terminal; based on the parking information, issuing a precedence pass for prioritizing an order of a user of the parking area to a queue in the facility, and associating the precedence pass with the parking information to be stored in storage means; receiving a use request of the precedence pass including parking information from the information terminal; collating parking information stored in the storage means with parking information included in the use request to determine whether the precedence pass is usable; and transmitting a determination result as to whether the precedence pass is usable to the information terminal. The information terminal receives a determination result from the precedence pass management system and controls an output of the information terminal in response to the determination result.

### Advantageous Effects of Invention

According to the disclosed subject matter, it makes possible to give a new incentive to users of a parking area relative to Park & Ride. Further, by promoting use of Park & Ride, it makes possible to suppress vehicles inflow into a congested area.

### BRIEF DESCRIPTION OF DRAWINGS

FIG. 1 is drawing for explaining positions of sightseeing facilities and parking areas in a Park & Ride system.

FIG. 2 is a schematic diagram illustrating a scheme of a Park & Ride system according to the first example embodiment.

FIG. 3 is a schematic diagram explaining a parking area in which a parking terminal is present of the first example embodiment.

FIG. 4 is a block diagram illustrating a configuration of a parking terminal in the first example embodiment.

FIG. 5 is a datasheet illustrating parking information of the first example embodiment.

FIG. 6 is an explanatory drawing illustrating a parking ticket issued by a parking terminal of the first example embodiment.

FIG. 7 is a block diagram illustrating a configuration of a precedence pass management system of the first example embodiment.

FIG. 8 is a datasheet illustrating precedence pass setting information of the first example embodiment.

FIG. 9 is a datasheet illustrating precedence pass data of the first example embodiment.

FIG. 10 is a block diagram illustrating a configuration of an information terminal according to the first example embodiment.

FIG. 11 is a datasheet illustrating a use request of the first example embodiment.

FIG. 12 is a sequence diagram illustrating partial operations of a Park & Ride system in the first example embodiment.

FIG. 13 is a sequence diagram illustrating partial operations of the Park & Ride system in the first example embodiment.

FIG. 14 is a schematic diagram illustrating a scheme of a Park & Ride system in the second example embodiment.

FIG. 15 is a block diagram illustrating a configuration of a parking terminal of the second example embodiment.

FIG. 16 is a block diagram illustrating a configuration of a user terminal of the second example embodiment.

FIG. 17 is a sequence illustrating partial operations of a Park & Ride system in the second example embodiment.

FIG. 18 is a schematic diagram illustrating a scheme of a Park & Ride system of the third example embodiment.

FIG. 19 is a schematic diagram for explaining a facility in which an information terminal is present of the third example embodiment.

FIG. 20 is a schematic diagram for explaining a facility in which an information terminal is present of the third example embodiment.

FIG. 21 is a block diagram illustrating a configuration of an information terminal of the third example embodiment.

FIG. 22 is a block diagram illustrating a configuration of a precedence pass management system of the third example embodiment.

FIG. 23 is a sequence illustrating partial operations of a Park & Ride system of the third example embodiment.

FIG. 24 is a block diagram illustrating a hardware configuration in which a precedence pass management system or the like is realized with a computer of the first example embodiment.

### DESCRIPTION OF EMBODIMENTS

To further promote the use of Park & Ride, one of incentives given to a user of a parking area is time. For example, as a compensation for the moving distance (travel time) from a distant place where a parking area of Park & Ride is present to a tourist spot, with a user of the parking area as a target, issuing of a precedence pass for prioritizing an order of users of the parking area to the queue caused in a sightseeing facility of a tourist spot can be considered.

Even if a time is taken to travel from the parking area to the tourist spot by using Park & Ride, a latency time by a queue or the like generated at a sightseeing facility of a tourist spot can be reduced using the precedence pass. Thus, as a whole, a user using Park & Ride can efficiently enjoy the sightseeing in a short time.

In the following example embodiments, the sightseeing facility at the tourist spot is described as an example, but an aspect is not limited thereto. For example, a tourist spot may be an area to which an influx of vehicles is suppressed, and may be a city area. Further, a facility for which a user of the parking area uses the precedence pass is not limited to a sightseeing facility, and may be a facility in which the queue is caused within the area. For example, a facility may be a facility for recreation (movie theater, concert venue) present in the city area. Note that a facility in which a user of the parking area uses the precedence pass is sometimes simply referred to as a facility by including sightseeing facility, facilities for recreation and the like.

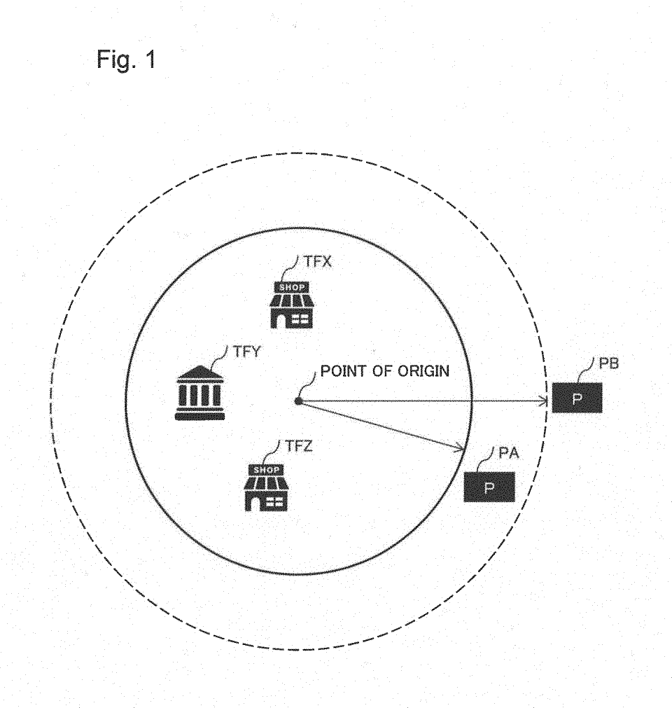

Hereinafter, a scheme of the Park & Ride system is described with reference to drawings. FIG. 1 is a drawing for explaining positions of sightseeing facilities and parking areas in the Park & Ride system. In FIG. 1, within a circle of a solid line with a point of origin as a center, an area to which an influx of vehicles is suppressed (hereinafter referred to as congested area) is schematically illustrated. At the inside of the congested area, sightseeing facilities TFX, TFY, and TFZ at which above described precedence pass can be used are present. Note that sightseeing facilities include not only facilities for amusement, watching or sports such as a theme park, a museum or the like, but also a restaurant, a lodging, a vendor or the like.

Further, parking areas PA and PB are parking areas for Park & Ride that are located at an outside than the congested area. The parking area PB is located at an outside of a circle of a broken line with the point of origin as the center, and in the following example embodiments, descriptions are given by assuming that the parking area PB is located at more distant place than the parking area PA.

### First Example Embodiment

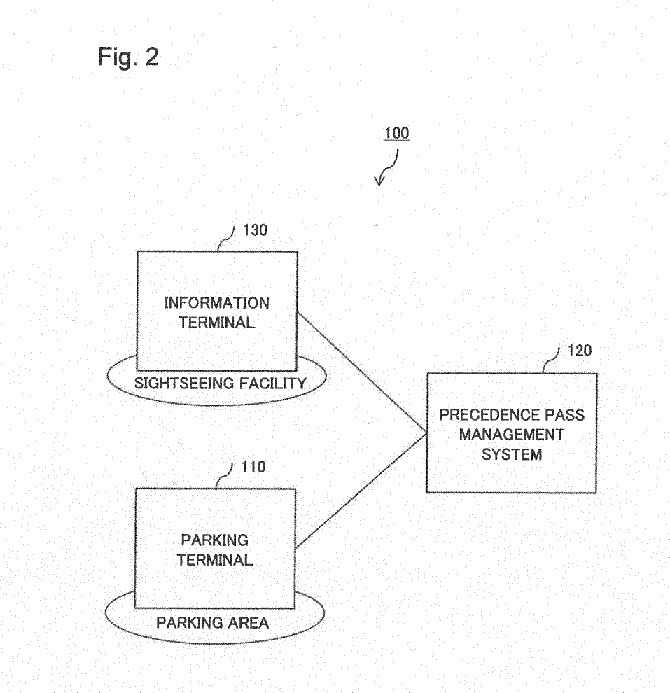

FIG. 2 is an explanatory drawing for explaining a scheme of the Park & Ride system of the first example embodiment. A Park & Ride system 100 illustrated in FIG. 2 includes a parking terminal 110, a precedence pass management system 120, and an information terminal 130. The precedence pass management system 120 is coupled with the parking terminal 110 and the information terminal 130 in a communicable manner. Hereinafter, configurations of the parking terminal 110, the precedence pass management system 120, and the information terminal 130 are described.

Parking Terminal

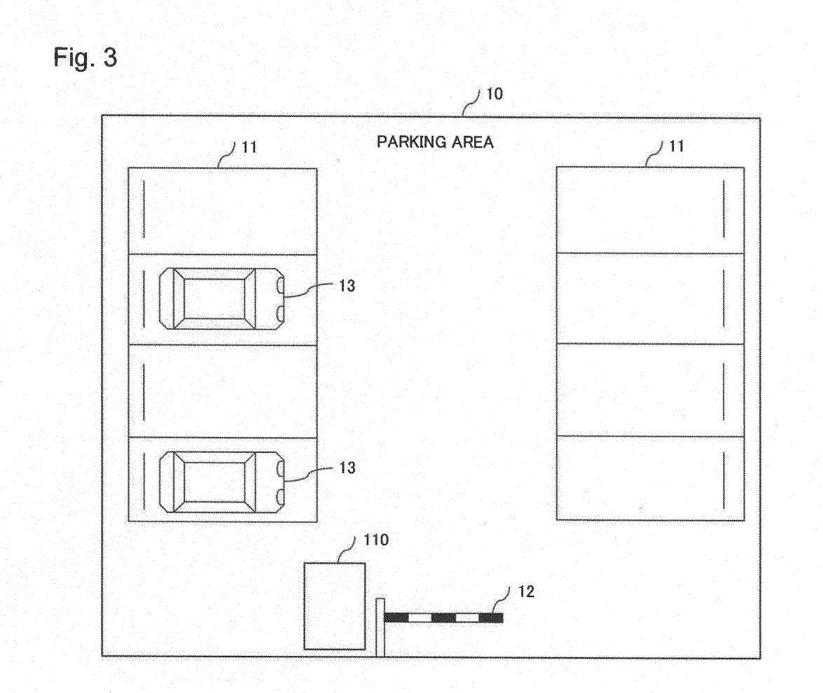

FIG. 3 is a schematic diagram explaining a parking area in which a parking terminal is present in the first example embodiment. Hereinafter, a parking area means a parking area for Park & Ride. As illustrated in FIG. 3, a parking area 10 includes a parking space 11, a passage gate 12, and the parking terminal 110. The parking space 11 is a space for parking a vehicle 13. The passage gate 12 is a device for controlling entrance/exit to/from the parking area 10. The parking terminal 110 is provided to, for example, an entrance of the parking area. The parking terminal 110 is a terminal for processing information on the use of the parking area and, for example, processes information on entrance/exit of a vehicle.

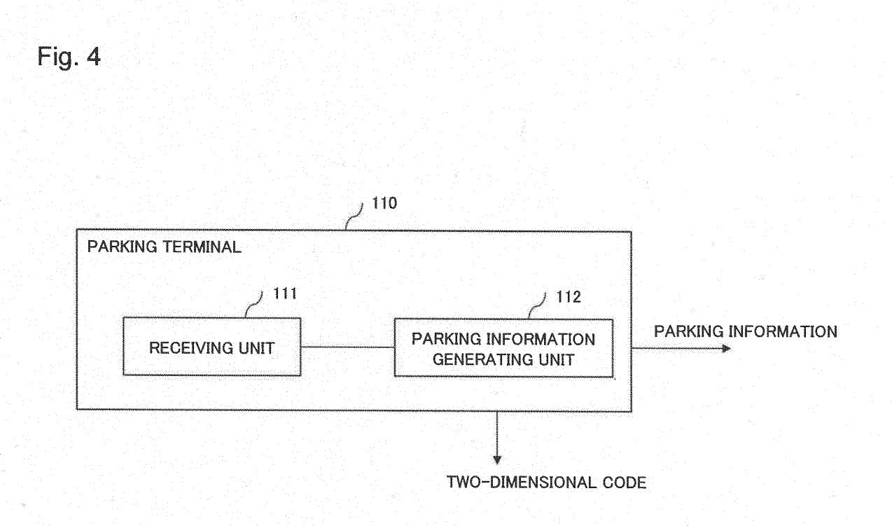

FIG. 4 is a block diagram illustrating a configuration of a parking terminal of the first example embodiment. The parking terminal 110 illustrated in FIG. 4 includes a receiving unit 111, a parking information generating unit 112, and a communication unit (not illustrated). The parking terminal 110, via the communication unit, communicates with the precedence pass management system 120.

The receiving unit 111 receives parking of the vehicle at the parking area 10. Receiving parking corresponds to pressing a ticketing button of the parking terminal 110 to issue, for example, the parking ticket.

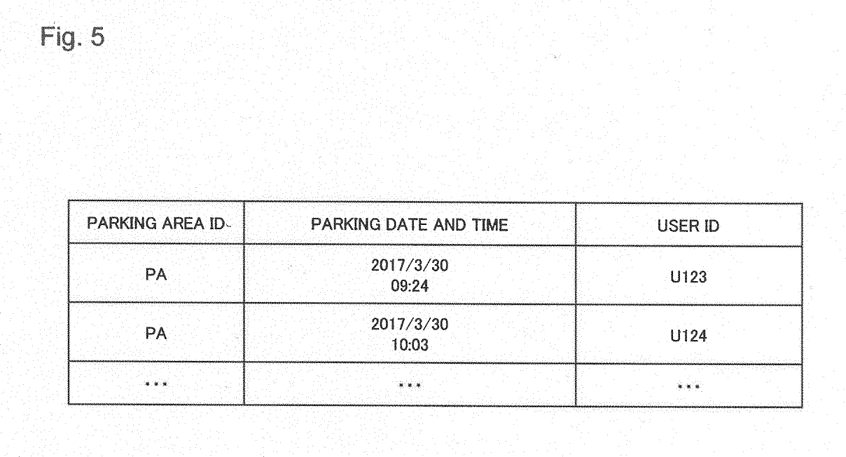

The parking information generating unit 112, in response to the parking reception, generates parking information. FIG. 5 is a datasheet that is generated by the parking terminal and represents the parking information. The parking information includes the parking area ID, parking date and time, and the user ID.

The parking area ID is an identifier for identifying the parking area. For example, the parking area ID is represented as “PA.” The parking date and time is date and time of parking start at the parking area. The parking date and time may be the date and time when the ticketing button is pressed at the receiving unit 111. The user ID is the identifier for identifying users of the parking area. The user ID may be, for example, a serial number generated by the parking information generating unit 112. Note that, hereinafter, sometimes users of the parking area are represented as parking area users or simply users.

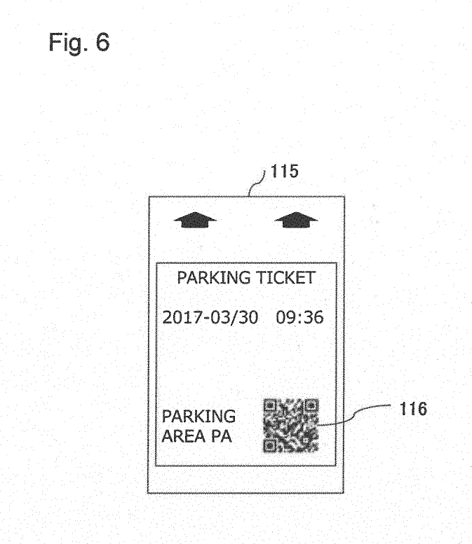

The parking information generating unit 112 performs the two-dimensional coding on the generated parking information, displays the parking information on the parking ticket, and issues the parking ticket. FIG. 6 is a schematic diagram illustrating the parking ticket including the two-dimensional code. In a parking ticket 115 illustrated in FIG. 6, the parking area name “parking area PA,” date and time when parking is started “Mar. 30, 2017 09:36,” and the two-dimensional code 116 are displayed.

The two-dimensional code generated by the parking information generating unit 112 includes pieces of information on the parking area ID, the parking date and time, and the user ID. Note that, if necessary parking information is included, materials other than the two-dimensional code may be used. Further, the parking ticket may be media other than the paper media and may be, for example, the resin media and the electronic media.

The parking terminal 110 transmits the parking information generated via the communication unit (not illustrated) to the precedence pass management system 120. A timing for the parking terminal 110 to transmit the parking information may be any timing before or after issuing the parking ticket.

Note that functions of the parking terminal 110 can be realized by diverting partial functions of a parking area automatic adjustment machine that is provided to, for example, the existing parking area.

Precedence Pass Management System

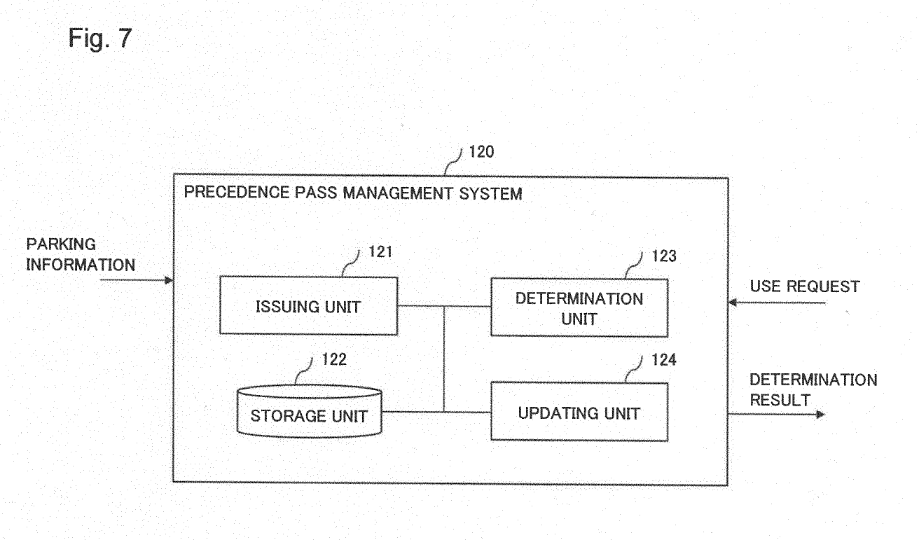

The precedence pass management system 120 is a system for processing information on the precedence pass. The precedence pass management system in the first example embodiment is described with reference to drawings. FIG. 7 is a block diagram illustrating a configuration of a precedence pass management system of the first example embodiment. The precedence pass management system 120 illustrated in FIG. 7 includes an issuing unit 121, a storage unit 122, a determination unit 123, an updating unit 124, and the communication unit (not illustrated). The precedence pass management system 120 is, via the communication unit, coupled with the parking terminal 110 and the information terminal 130 in a communicable manner.

The issuing unit 121 receives, from the parking terminal 110, parking information indicating the use of the parking area. The issuing unit 121, based on the received parking information, to the queue in the sightseeing facility, issues the precedence pass for prioritizing an order of users of the parking area. The issuing unit 121 associates the precedence pass with the parking information to be stored in the storage unit 122.

Specifically, the issuing unit 121 refers to the precedence pass setting information stored in the storage unit 122 in advance. The issuing unit 121 associates effective number of times corresponding to the parking area ID of the received parking information or the expiration date corresponding to the parking date and time with the parking information to be stored in the storage unit 122 as the precedence pass data.

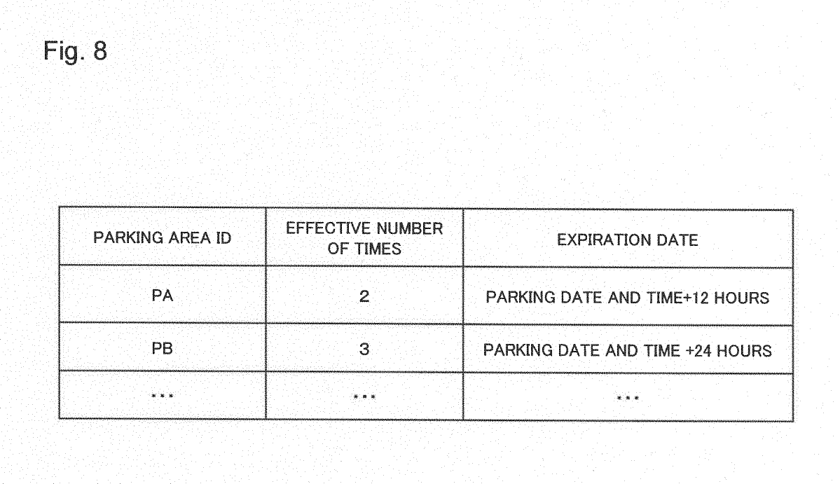

FIG. 8 is a datasheet illustrating the precedence pass setting information. To the precedence pass setting information, the effective number of times for each parking area ID and the expiration date are set. The precedence pass setting information in FIG. 8 includes that when the parking area ID is “PA”, the effective number of times of the precedence pass is “2” and the expiration date is “parking date and time+12 hours”, and when the parking area ID is “PB”, the effective number of times of the precedence pass is “3” and the expiration date is “parking date and time+24 hours”.

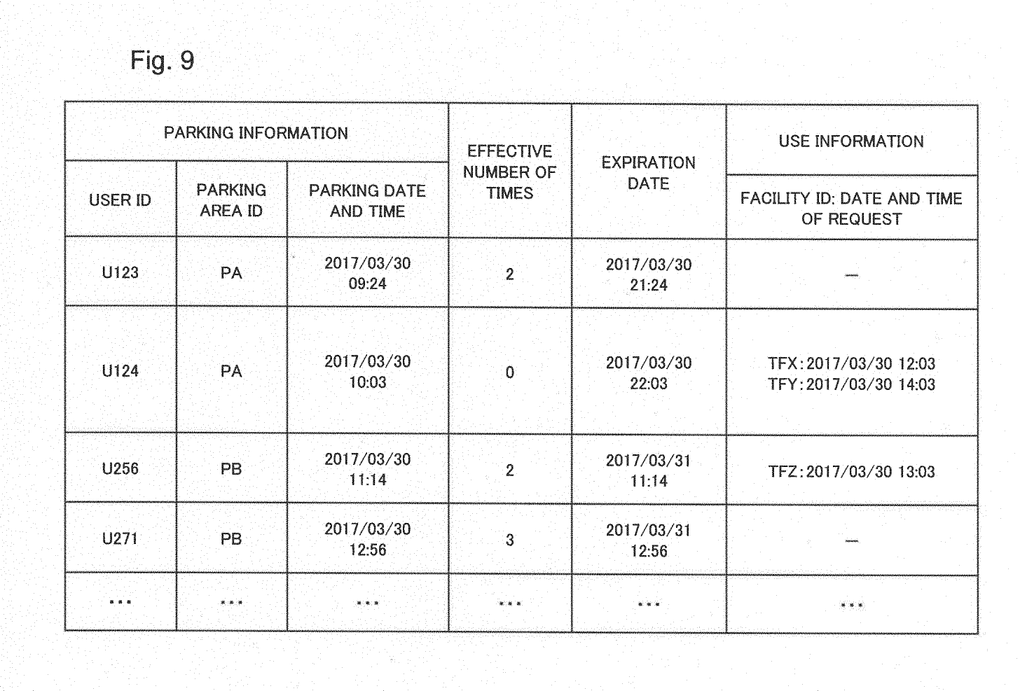

FIG. 9 is a datasheet illustrating the precedence pass data stored in the storage unit 122. In an example of the precedence pass data illustrated in FIG. 9, with the parking information in which the user ID is “U123” the parking area ID is “PA” and parking date and time is “Mar. 30, 2017 09:24” the effective number of times of the precedence pass “2” and the expiration date“Mar. 30, 2017 21:24” are associated.

The determination unit 123 receives, from the information terminal 130, the use request of the precedence pass including the parking information. Details of the use request are described later. The determination unit 123 collates the parking information stored in the storage unit 122 with the parking information included in the use request and determines whether the precedence pass is usable. The determination unit 123 transmits the determination result as to whether the precedence pass is usable to the information terminal 130.

Specifically, first, the determination unit 123 collates whether the parking information included in the use request is included in the precedence pass data of the storage unit 122. When the parking information is not included in the precedence pass data, the determination unit 123 determines that the precedence pass may not be used for the parking information included in the use request.

Next, when the parking information included in the use request is included in the precedence pass data, by referring to the effective number of times of the precedence pass data and the expiration date, whether the precedence pass is usable is determined. Specifically, upon receiving, from the information terminal 130, the use request including the parking information, when the effective number of times of the precedence pass data associated with the parking information is “one” or more and date and time when the use request is received is within the expiration date, the determination unit 123 determines that the precedence pass associated with the parking information included in the use request is “usable.” Otherwise, the determination unit 123 determines as “unusable.” On the other hand, when the determination unit 123 determines that the precedence pass is “usable,” the determination unit 123 instructs the updating unit 124 to perform an update process of the precedence pass.

In accordance with the instruction of the data update process, among the precedence pass data stored in the storage unit 122, the updating unit 124 reduces one time from the effective number of times of the parking information based on which the determination is made that the precedence pass is usable, and adds the facility ID included in the use request and the date and time when the use request is received as use information. Note that the update process of the effective number of times by the updating unit 124 includes updating the effective number of times of the precedence pass data stored in the storage unit 122 from “one” to “zero.” In the example of FIG. 9, relative to the parking information including the user ID “U256,” the effective number of times is “two” and the use information, i.e., a combination of the facility ID and the date and time of request “TFZ:Mar. 30, 2017 13:03” is appended.

After completing the update process of the effective number of times, the determination unit 123 transmits the determination result as to whether the precedence pass is usable to the information terminal 130 via the communication unit. The determination unit 123 may transmit the updated effective number of times of the precedence pass together with determination result to the information terminal 130.

After determining as to whether the precedence pass is usable and before starting the update process of the effective number of times, the determination unit 123 may transmit the determination result as to whether the precedence pass is usable to the information terminal 130.

Information Terminal

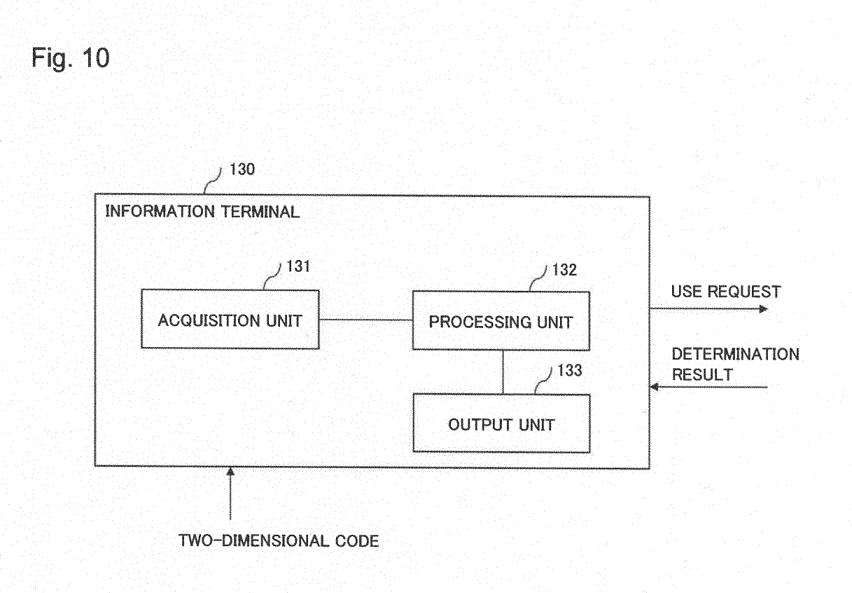

Next, the information terminal of the Park & Ride system is described with reference to the drawings. The information terminal 130 is a terminal present in the sightseeing facility within the congested area. FIG. 10 is a block diagram illustrating a configuration of the information terminal of the first example embodiment. The information terminal 130 illustrated in FIG. 10 includes an acquisition unit 131, a processing unit 132, an output unit 133, and a communication unit (not illustrated). The information terminal 130 is, via the communication unit, coupled with the precedence pass management system 120 in a communicable manner.

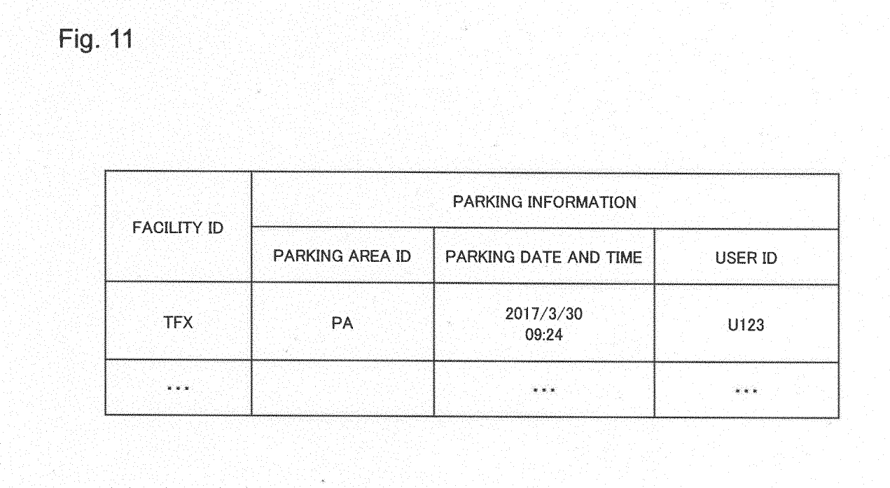

The processing unit 132, using the acquired parking information, creates the use request of the precedence pass. FIG. 11 is a datasheet illustrating the use request of the precedence pass of the first example embodiment. The use request illustrated in FIG. 11 includes the facility ID for identifying the sightseeing facility and the parking information that is obtained from the two-dimensional code of a user. The processing unit 132, via the communication unit, transmits the use request of the precedence pass to the precedence pass management system 120.

The processing unit 132, in response to the determination result transmitted form the precedence pass management system 120, controls an output of the output unit 133. The output unit 133 is a display or a sound tool. One example of the display is a liquid-crystal display and one example of the sound tool is a speaker. For example, the processing unit 132, when as the determination result, the precedence pass can be used, controls the display to display “o” and when the precedence pass may not be used, controls the display to display “x.” Alternatively, the processing unit 132, when the precedence pass can be used, controls the display to be displayed in green and when the precedence pass may not be used, controls the display to be displayed in red. The processing unit 132 may control sounds of the sound tool in such a way that different sounds are sounded in response to the determination result.

As above, the processing unit 132 controls the output of the output unit 133 in response to the determination result, and whereby employees of the facility in which the information terminal is present can determine whether the precedence pass of the parking area users is usable.

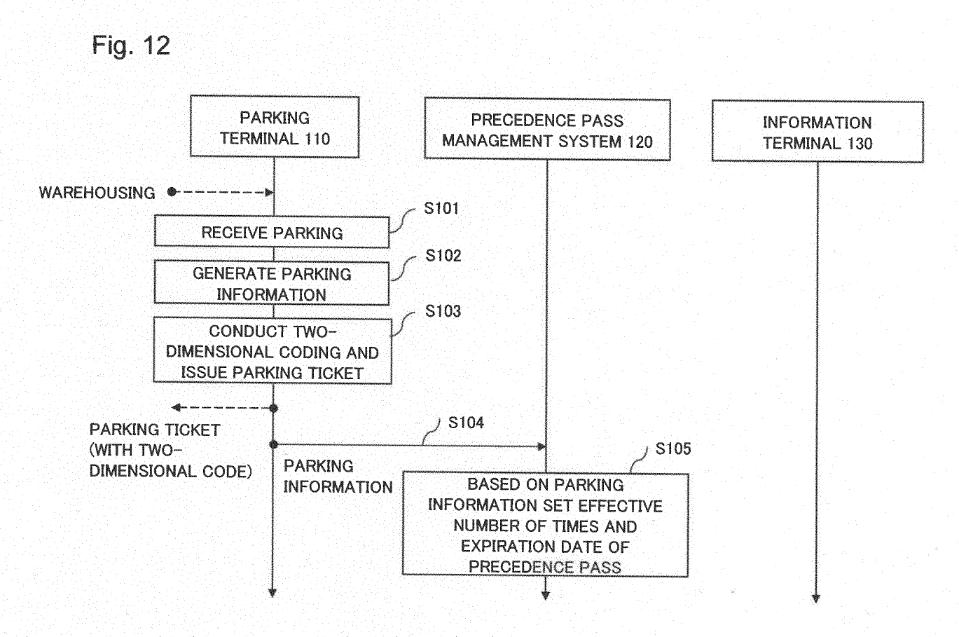

Operations of the Park & Ride system of the first example embodiment are described with reference to the drawings. FIG. 12 is a sequence diagram illustrating processes from the warehousing to the parking area to issuing of the precedence pass among the operations of the Park & Ride system.

The receiving unit 111 of the parking terminal 110, when the ticketing button of the parking terminal 110 is pressed, receives the parking of the vehicle in the parking area 10 (step S101) and notifies the parking information generating unit 112 of the warehousing of the vehicle 13.

The parking information generating unit 112 generates parking information that is obtained by associating the parking area ID, the parking date and time, and the user ID (step S102). For example, the parking information generating unit 112 assumes the date and time when the ticketing button is pressed as the parking date and time and associates the parking area ID for identifying the parking area with the user ID.

Next, the parking information generating unit 112 conducts the two-dimensional coding to the parking information including the parking area ID, the parking date and time, and the user ID, and issues the parking ticket to which a two-dimensional code is printed (step S103).

Further, the parking information generating unit 112 transmits the generated parking information, via the communication unit, to the precedence pass management system 120.

The issuing unit 121 of the precedence pass management system 120 receives, from the parking terminal 110, the parking information (step S104). The issuing unit 121, based on the received parking information, to the queue in the facility, issues the precedence pass for prioritizing an order of users of the parking area and associates the precedence pass with the parking information to be stored in the storage unit 122. Specifically, the issuing unit 121 based on the parking area ID included in the parking information, refers to the precedence pass setting information and sets the effective number of times of the precedence pass. Further, the issuing unit 121, using the parking date and time included in the received parking information, refers to the precedence pass setting information and sets the expiration date of the precedence pass (step S105).

The effective number of times or the expiration date included in the precedence pass setting information differs depending on positions of the parking area. In the example of FIG. 1 of the first example embodiment, setting of the effective number of times or the expiration date is different depending on distances from the point of origin within the circle indicating the congested area to the parking areas PA and PB.

For example, by increasing the effective number of times of the precedence pass or extending the expiration date relative to the parking area that is more distant from the point of origin indicating a predetermined position within the congested area, users can receive larger incentives within the congested area. Users of the parking area who wish to use the precedence pass at a plurality of sightseeing facilities come to park the vehicles at more distant parking areas from the congested area, and thus, it is possible to further keep away vehicles from the congested area.

The precedence pass setting information can be set in such a way that as a distance from a boundary of the congested area to the parking area is increased, the effective number of times is increased and the expiration date is extended. Further, the precedence pass setting information can be set in such a way that as a distance from the sightseeing facility within the congested area to the parking area is increased, the effective number of times is increased and the expiration date is extended.

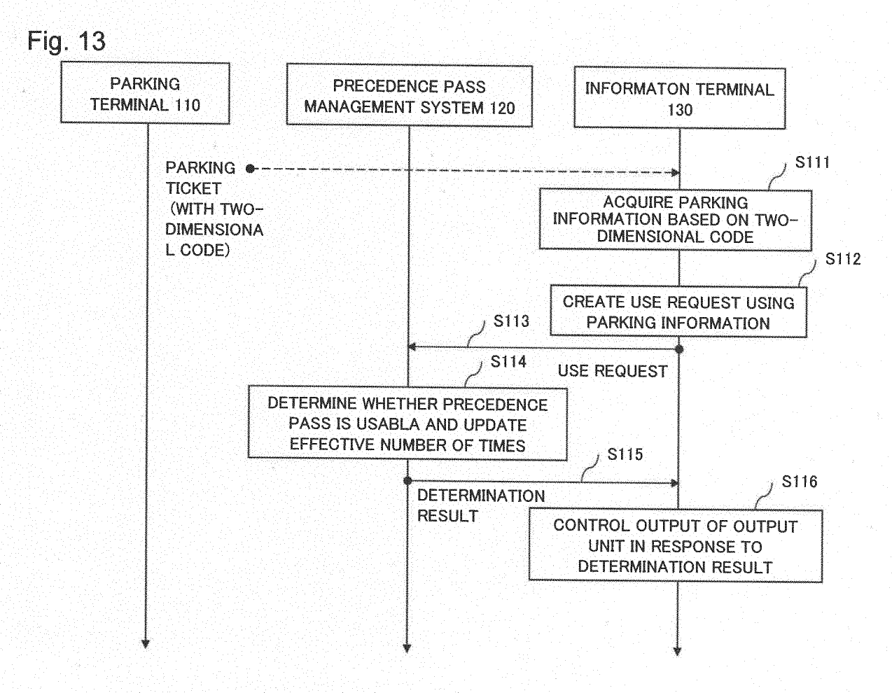

FIG. 13 is, among the operations of the Park & Ride system, the sequence diagram illustrating the process from the use request of the precedence pass to an output of the determination result.

The acquisition unit 131 of the information terminal 130 reads the two-dimensional code printed on the parking ticket of the user and, from the two-dimensional code, acquires the parking information of the user (step S111). The processing unit 132 of the information terminal 130, using the acquired parking information, creates the use request of the precedence pass including the parking information (step S112) and transmits the use request of the precedence pass to the precedence pass management system 120.

The determination unit 123 of the precedence pass management system 120 receives, from the information terminal 130 present in the sightseeing facility, the use request of the precedence pass (step S113). The determination unit 123 collates the parking information stored in the storage unit 122 with the parking information included in the use request and determines whether the precedence pass is usable. When the determination unit 123 determines that the precedence pass is usable, the determination unit 123 causes the updating unit 124 to update the effective number of times of the precedence pass (step S114). Specifically, the determination unit 123 instructs the update process of the precedence pass. The updating unit 124 receives the instruction of the data update process, among the precedence pass data stored in the storage unit 122, reduces one time from the effective number of times of the parking information based on which the determination is made as usable, stores the reduced effective number of times in the storage unit 122, and updates the effective number of times. The updating unit 124 assumes the facility ID included in the use request and the date and time when the use request is received as the use information and associates the use information with the updated precedence pass data in such a way to be stored in the storage unit 122.

The determination unit 123 of the precedence pass management system 120 transmits the determination result to the information terminal 130 (step S115).

The processing unit 132 of the information terminal 130 receives, from the precedence pass management system 120, the determination result and in response to the determination result, controls an output of the output unit 133 (step S116). For example, the output unit 133 is the sound tool and the processing unit 132, in response to the determination result, controls the sound tool in such a way that different sounds are sounded. The employees of the sightseeing facility in which the information terminal 130 is present can determine whether the precedence pass of the parking area users is usable based on the determination result output from the output unit 133.

### Effect of First Example Embodiment

According to the first example embodiment, it becomes possible to give an incentive of a time to the parking area users of Park & Ride. This is because, by using the precedence pass issued by the precedence pass management system, the parking area users can reduce the latency time caused by the queue in the facility within the congested area. Accordingly, the parking area users of Park & Ride can highly time-efficiently enjoy the sightseeing.

Further, according to the first example embodiment, by further promotion of utilization of Park & Ride, the influx of vehicles to the congested area can be suppressed.

### Second Example Embodiment

The precedence pass management system of the second example embodiment is described with reference to the drawings. In an example of the first example embodiment, the parking terminal 110 transmits the parking information to the precedence pass management system 120, but in an example of the second example embodiment, a user terminal 240 of the parking area users transmits, to the precedence pass management system 120, the parking information.

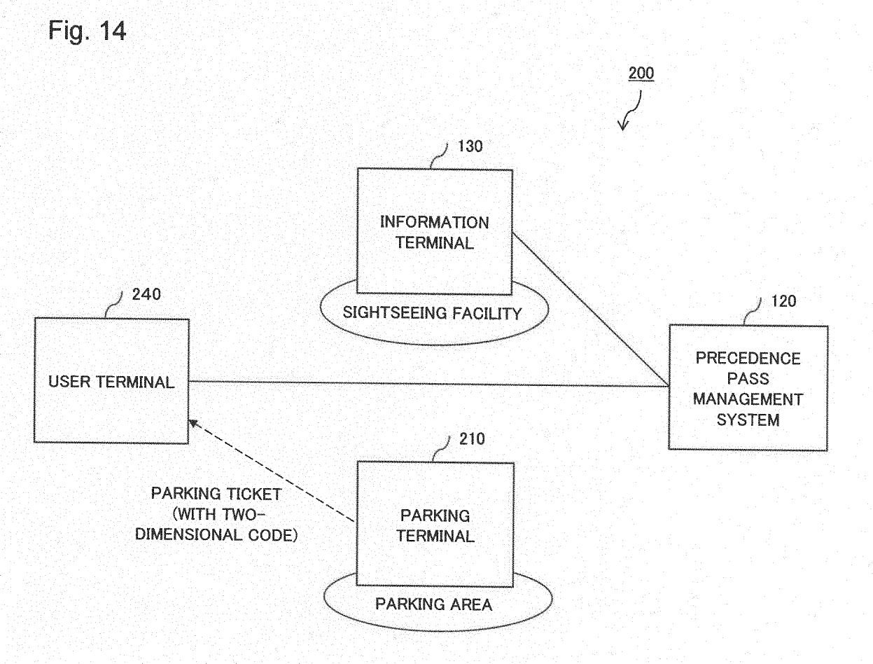

FIG. 14 is a schematic diagram illustrating a scheme of the Park & Ride system of the second example embodiment. The Park & Ride system 200 illustrated in FIG. 14 includes the parking terminal 210, the precedence pass management system 120, the information terminal 130, and the user terminal 240. The precedence pass management system 120 of the second example embodiment is coupled with the user terminal 240 and the information terminal 130 in a communicable manner. Hereinafter, mainly, configurations of the parking terminal 210 and the user terminal 240 in the second example embodiment are described.

Parking Terminal

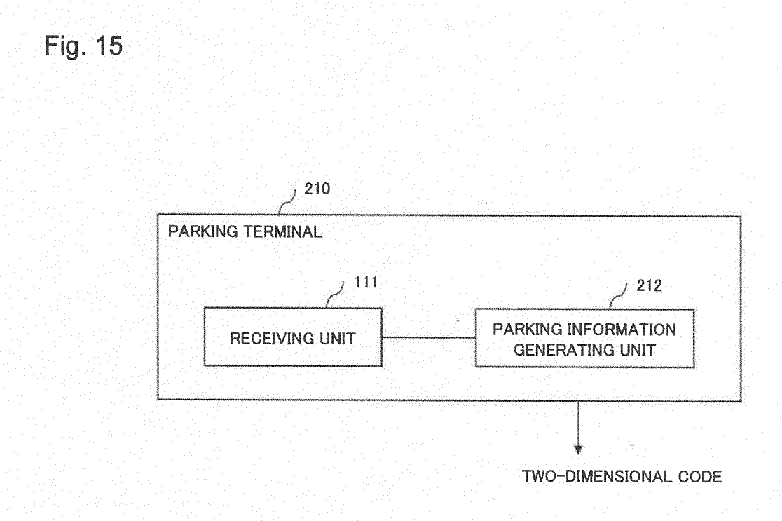

FIG. 15 is a block diagram illustrating a configuration of a parking terminal of the second example embodiment. The parking terminal 210 illustrated in FIG. 15 includes the receiving unit 111 and a parking information generating unit 212. Among configurations of the parking terminal 210 of the second example embodiment, a configuration which is identical with the configuration of the parking terminal 110 of the first example embodiment is denoted with an identical reference numeral and detailed descriptions thereof are omitted.

The parking information generating unit 212 of the second example embodiment is different from the parking information generating unit 112 of the first example embodiment in that while the parking information generating unit 212 of the second example embodiment does not transmit the parking information that is generated after the parking reception to the precedence pass management system 120, the parking information generating unit 112 of the first example embodiment transmits the parking information. The parking information generating unit 212 has the same function as the parking information generating unit 112 of the first example embodiment except for not transmitting the parking information to the precedence pass management system 120. In the second example embodiment, the parking information generated by the parking terminal 210 is, via the user terminal 240, transmitted to the precedence pass management system 120.

User Terminal

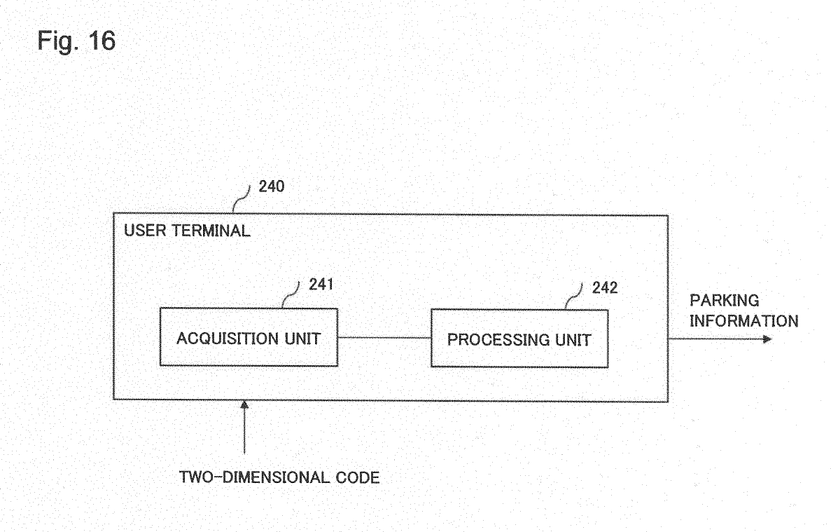

FIG. 16 is a block diagram illustrating a configuration of a user terminal of the second example embodiment. The user terminal 240 illustrated in FIG. 16 includes an acquisition unit 241, a processing unit 242, and a communication unit (not illustrated). The acquisition unit 241 reads the two-dimensional code printed on the parking ticket issued by the parking terminal 210, and from the two-dimensional code of the parking ticket, acquires the parking information. The processing unit 242 transmits the acquired parking information to the precedence pass management system 120.

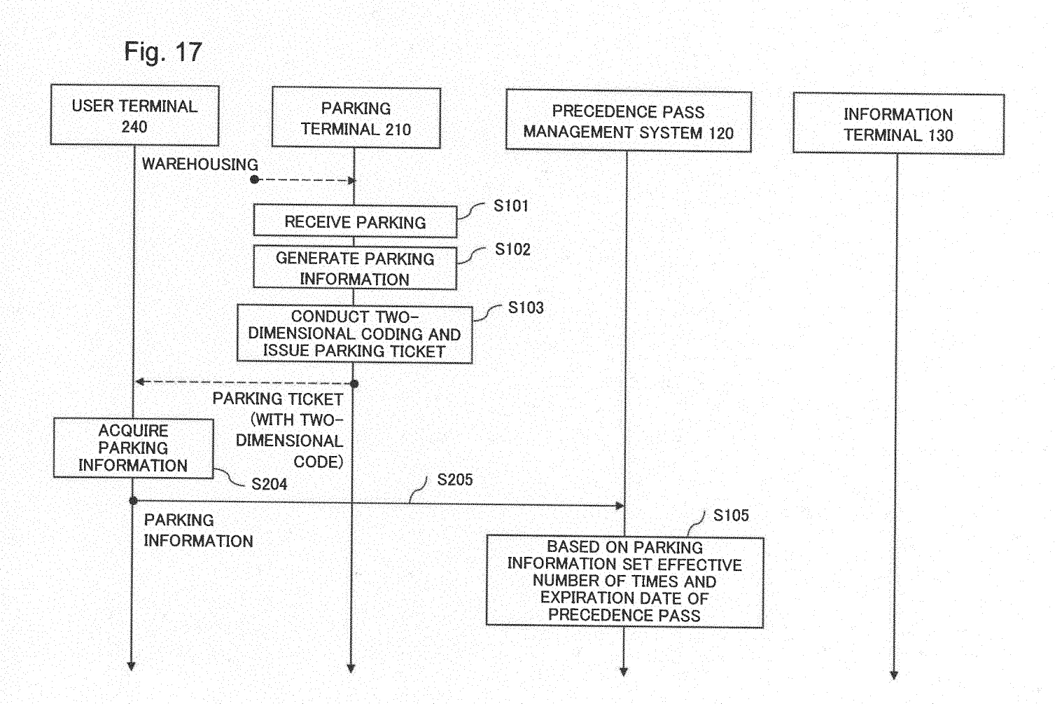

Next, operations of the Park & Ride system of the second example embodiment are described with reference to the drawings. FIG. 17 is, among the operations of the Park & Ride system, a sequence diagram illustrating the process from warehousing to parking area to issuing of the precedence pass.

Among the processes from warehousing to the parking area to issuing the precedence pass illustrated in FIG. 17, step S101 to step S103 are the same as the operations of the first example embodiment illustrated in FIG. 12, and thus, detailed descriptions thereof are omitted.

After step S103, the acquisition unit 241 of the user terminal 240 reads the two-dimensional code printed on the parking ticket issued by the parking terminal 210, and based on the two-dimensional code of the parking ticket, acquires the parking information (step S204). The user terminal 240 transmits the acquired parking information to the precedence pass management system 120.

The issuing unit 121 of the precedence pass management system 120 receives, from the user terminal 240, the parking information (step S205). The issuing unit 121, based on the received parking information, to the queue in the facility, issues the precedence pass for prioritizing an order of users of the parking area and associates the precedence pass with the parking information to be stored in the storage unit 122. Specifically, the issuing unit 121, based on the parking area ID included in the parking information, refers to the precedence pass setting information and sets the effective number of times of the precedence pass. Further, the issuing unit 121, using the parking date and time included in the received parking information, refers to the precedence pass setting information and sets the expiration date of the precedence pass (step S105).

Although in an example of the second example embodiment, before transmitting the parking information to the precedence pass management system 120, the user terminal 240, based on the two-dimensional code of the parking ticket, acquires the parking information, an example embodiment is not limited thereto. For example, as the parking information, an image of the two-dimensional code as it is may be transmitted to the precedence pass management system 120. In that case, the issuing unit 121 of the precedence pass management system 120 decodes the received two-dimensional code image to retrieve the parking information.

### Effect of Second Example Embodiment

The second example embodiment has an effect similar to that of the first example embodiment. Further, according to the second example embodiment, the parking terminal 110 does not need to transmit, to the precedence pass management system 120, the parking information, and thus, functions can be omitted. The parking information is transmitted from the user terminal 240 to the precedence pass management system 120, and thus, only when parking area users need the precedence pass, the parking information may be transmitted to the precedence pass management system 120. Accordingly, the number of pieces of parking information is reduced, and thus, the precedence pass management system 120 of the second example embodiment can reduce the storage resources of the storage unit.

### Third Example Embodiment

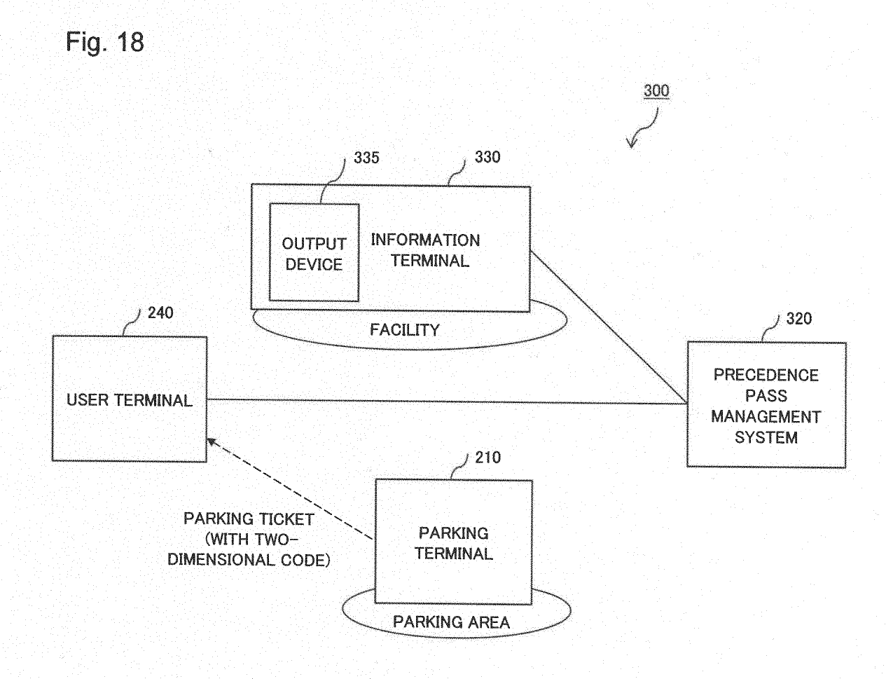

The Park & Ride system of the third example embodiment is described with reference to the drawings. FIG. 18 is a schematic diagram illustrating a scheme of the Park & Ride system of the third example embodiment. A Park & Ride system 300 illustrated in FIG. 18 includes a parking terminal 210, a precedence pass management system 320, an information terminal 330, and a user terminal 240. The precedence pass management system 320 is coupled with the user terminal 240 and the information terminal 330 in a communicable manner. The information terminal 330 includes an output device 335. The output device 335 is a device to be controlled by the information terminal 330.

The information terminal 330 of the third example embodiment differs from the information terminal 130 of the second example embodiment in that the information terminal 330 of the third example embodiment, in response to the determination result, controls the output device 335. Further, the precedence pass management system 320 of the third example embodiment differs from the precedence pass management system 120 of the second example embodiment in that the precedence pass management system 320 of the third example embodiment receives an output result transmitted from the output device 335 and associates the output result with the precedence pass to be stored in the storage unit 122. Still further, the precedence pass management system 320 of the third example embodiment differs from the precedence pass management system 120 of the second example embodiment in that the precedence pass management system 320 of the third example embodiment updates the effective number of times of the precedence pass in response to the output result transmitted from the output device 335.

Hereinafter, as an example of the output device 335, descriptions are given by taking examples of a gate provided to a stadium entrance and a store cash register provided to a supermarket.

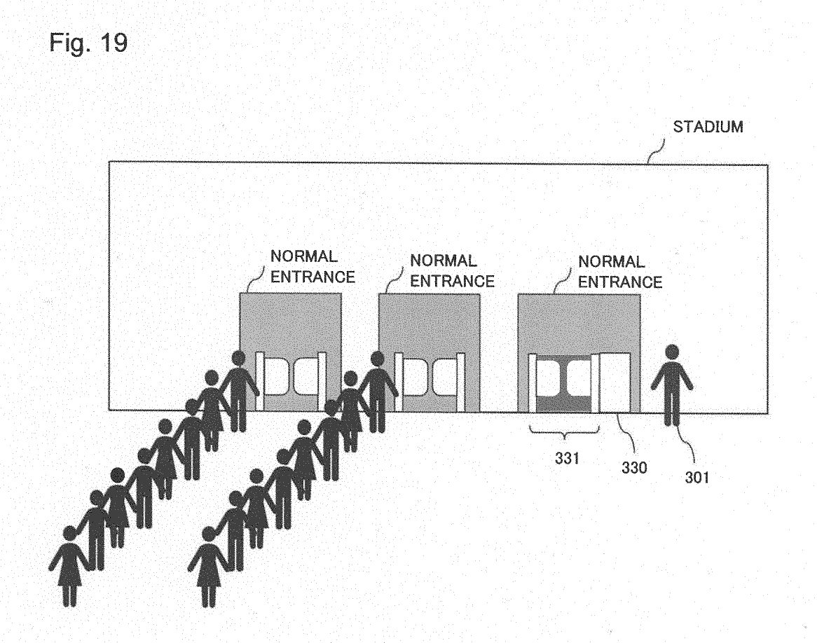

FIG. 19 is a schematic diagram illustrating a stadium entrance applied with the information terminal of the third example embodiment. For the stadium illustrated in FIG. 19, two types of entrances, i.e., the precedence entrance and the normal entrance are provided. In front of the precedence entrance, a user 301 who uses the precedence pass lines, and in front of the normal entrance, persons who may not have the precedence pass line. The normal entrance is an entrance through which a person enters the stadium in an order in which the person arrives at the entrance.

Provided to the precedence entrance is a gate 331 for a user who can use the precedence pass. When the queue is caused at the normal entrance, the user 301 passes the gate 331 of the precedence entrance in such a way to reduce the latency time taken until entering the stadium.

The information terminal 330 is coupled with the gate to be controlled 331 in a communicable manner. The information terminal 330 reads the two-dimensional code of the parking ticket of the user 301 who uses the precedence pass at the precedence entrance and transmits, to the precedence pass management system 320, the use request of the precedence pass of the parking ticket of the user 301. The information terminal 330 receives, from the precedence pass management system 320, the determination result, and in response to the determination result, controls opening and closing of the gate 331. Specifically, when the precedence pass can be used, the information terminal 330 controls the gate 331 and opens the flapper in such a way that the user 301 can enter from the precedence entrance. On the other hand, when the precedence pass may not be used, the information terminal 330 keeps a state of closing the flapper of the gate 331 to prevent the user from entering through the precedence entrance.

The information terminal 330 transmits the output result indicating the control of the gate 331, to the precedence pass management system 320. The output result is, for example, an output result indicating that the flapper of the gate 331 is opened and closed.

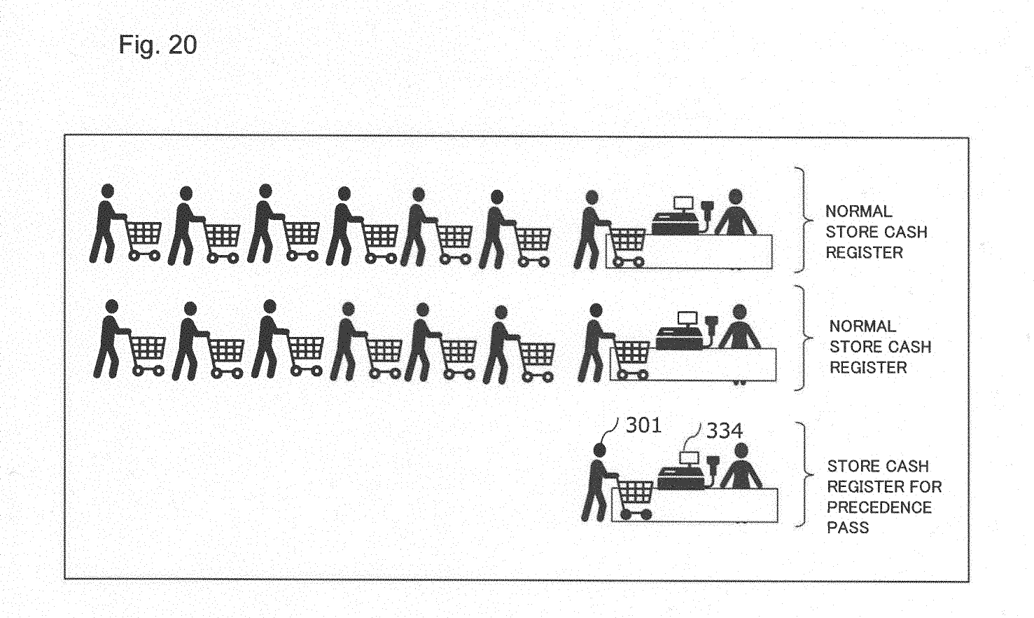

FIG. 20 is a schematic diagram illustrating an example in which the information terminal is applied to the store cash register of the supermarket of the third example embodiment. For the supermarket illustrated in FIG. 20, two types of entrances, i.e., a store cash register for precedence pass 334 and a normal store cash register are provided. In a lane of the store cash register for precedence pass 334 (hereinafter, simply referred to as store cash register 334), the user 301 who uses the precedence pass lines and in a lane of the normal store cash register, persons who may not use the precedence passs line. When the queue is caused at the normal store cash register, the user 301 uses the store cash register for precedence pass 334 and accordingly a time taken until starting the settlement of the products at the store cash register can be reduced.

The store cash register 334 of FIG. 20 is a device obtained by conducting interior decorating to the information terminal 330. The information terminal 330 reads the two-dimensional code of the parking ticket of the user 301 who uses the precedence pass at the store cash register 334, and transmits the use request of the precedence pass of the parking ticket of the user 301 to the precedence pass management system 320. The information terminal 330 receives, from the precedence pass management system 320, the determination result, and in response to the determination result, controls the account processing at the store cash register 334. Specifically, when the precedence pass can be used, the information terminal 330 can read a product bar code at the store cash register 334. On the other hand, when the precedence pass may not be used, the information terminal 330 may not read the product bar code at the store cash register 334.

The information terminal 330 transmits the output result indicating the control of the store cash register 334 to the precedence pass management system 320. The output result is, for example, a result indicating that a product bar code reading function is turned on at the store cash register 334.

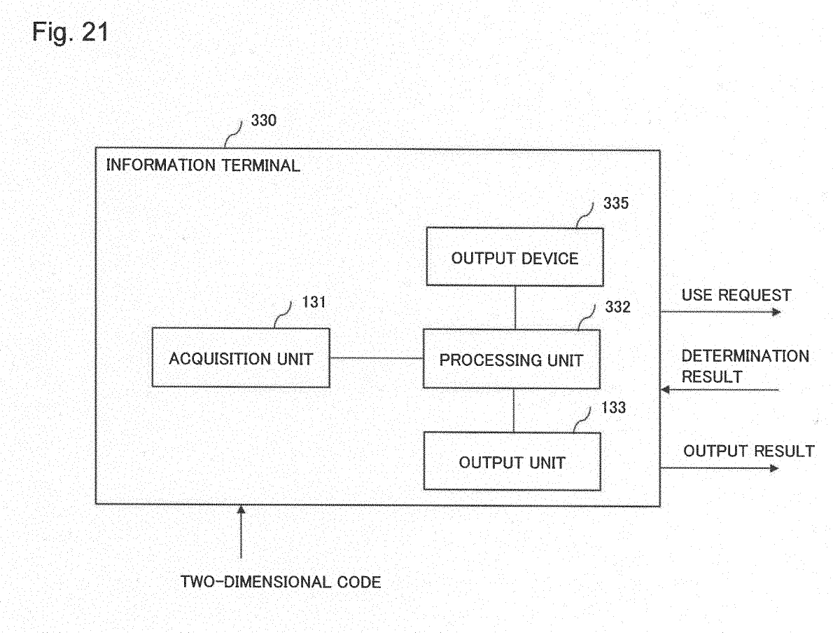

First, a configuration of the information terminal of the third example embodiment is described with reference to the drawings. FIG. 21 is a block diagram illustrating a configuration of the information terminal of the third example embodiment. The information terminal 330 illustrated in FIG. 21 includes an acquisition unit 131, a processing unit 332, an output unit 133, and a communication unit (not illustrated). The information terminal 130 is, via the communication unit, coupled with the precedence pass management system 120 and the output device 335 in a communicable manner. Among the configurations of the information terminal 330 of the third example embodiment, a configuration identical with configurations of the precedence pass management system of the first example embodiment and the second example embodiment is denoted with an identical reference numeral, and detailed descriptions thereof are omitted. Differences between the processing unit 332 of the information terminal 330 of the third example embodiment and the processing unit 132 of the information terminal 130 of the second example embodiment are described.

As similar to the processing unit 132, the processing unit 332, using the acquired parking information, creates the use request of the precedence pass and in response to the determination result transmitted from the precedence pass management system 120, controls an output of the output unit 133. Further, the processing unit 332, in response to the determination result, controls the output device 335. An example of the output device 335 is the gate 331 illustrated in FIG. 19 or the store cash register 334 illustrated in FIG. 20. When, for example, as the determination result, the precedence pass can be used, the processing unit 332 transmits the control signal for temporarily opening the flapper of the gate 331 to the gate 331. When the precedence pass may not be used, the processing unit 332 does not transmit the control signal to the gate 331.

The information terminal 330 receives, from the output device 335, the output result and transmits the output result to the precedence pass management system 320.

Next, a configuration of the precedence pass management system of the third example embodiment is described with reference to the drawings. Among configurations of the precedence pass management system 320 of the third example embodiment, a configuration identical with the configurations of the precedence pass management system of the first example embodiment and the second example embodiment is denoted with identical reference numerals and detailed descriptions thereof are omitted. The precedence pass management system 320 of the third example embodiment receives the output result transmitted from the output device 335 and associates the output result with the precedence pass to be stored in the storage unit 122.

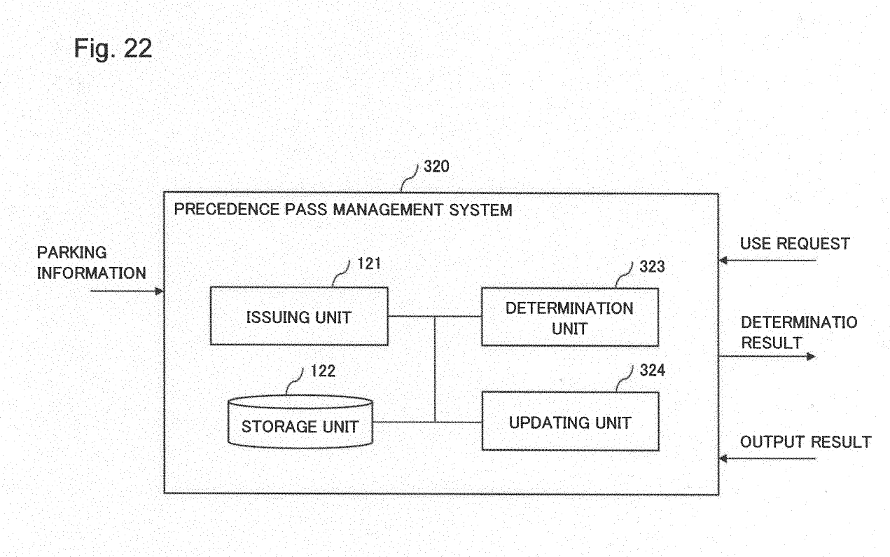

FIG. 22 is a block diagram illustrating a configuration of the precedence pass management system of the third example embodiment. The precedence pass management system 320 illustrated in FIG. 22 includes an issuing unit 121, a storage unit 122, a determination unit 323, and an updating unit 324.

The determination unit 323 receives, from the information terminal 330, the use request of the precedence pass including the parking information. The determination unit 323 collates the parking information stored in the storage unit 122 with the parking information included in the use request and determines whether the precedence pass is usable. The determination unit 323 transmits the determination result as to whether the precedence pass is usable to the information terminal 330. When the determination unit 323 determines that the precedence pass is usable, the determination unit 323 instructs the updating unit 324 to conduct the update process of the precedence pass.

The updating unit 324 receives, from the information terminal 330, the output result of the output device 335 and the update process of the precedence pass. The updating unit 324, after both of the update instruction of the precedence pass and the output result of the output device 335 are ready, starts the update process of the precedence pass. The updating unit 324, among the precedence pass data stored in the storage unit 122, reduces one time from the effective number of times of the parking information based on which the determination is made that the precedence pass is usable, and adds the facility ID included in the use request and the date and time when the use request is received as the use information. The updating unit 324 stores the output result associated with the precedence pass to the storage unit 122. For example, when the sightseeing facility is the stadium illustrated in FIG. 19, in the space for the use information of the precedence pass data stored in the storage unit 122, gate opening and closing information indicating entering through the precedence entrance is recorded.

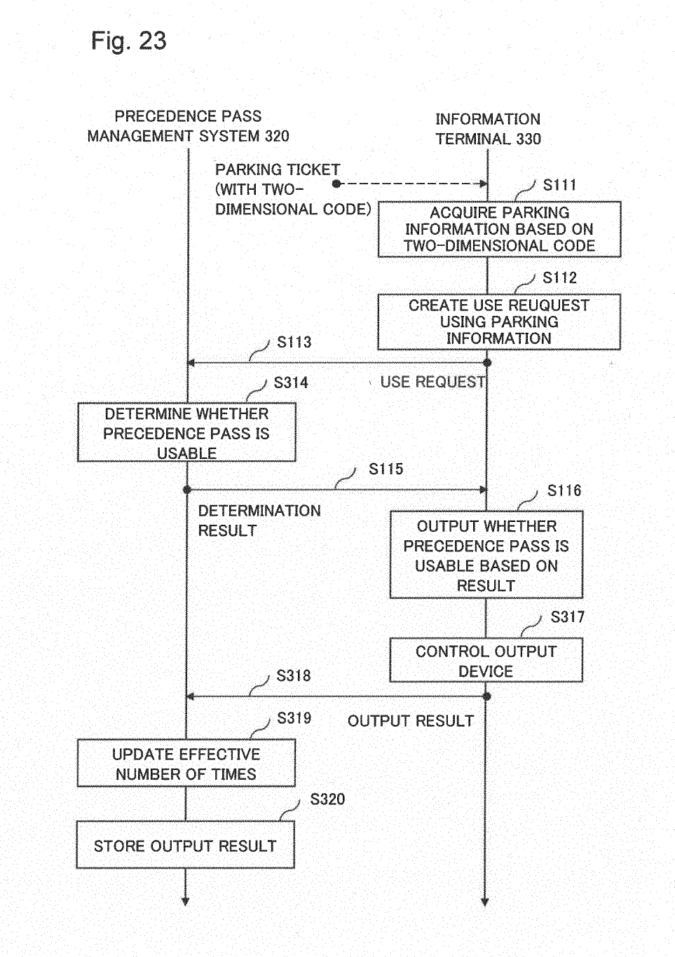

Operations of the Park & Ride system of the third example embodiment are described with reference to the drawings. FIG. 23 is a sequence illustrating partial operations of the Park & Ride system of the third example embodiment. The sequence diagram illustrated in FIG. 23 is a sequence diagram illustrating a process of acquiring, at the information terminal 330, the parking information and processes thereafter. In the descriptions of FIG. 23, an operation which is the same as that of the Park & Ride system of the first example embodiment illustrated in FIG. 13 is denoted with an identical step number, and detailed descriptions thereof are omitted.

The determination unit 323 of the precedence pass management system 320 receives, from the information terminal 130, the use request of the precedence pass (step S113). The determination unit 323 collates the parking information stored in the storage unit 122 with the parking information included in the use request and determines whether the precedence pass is usable (step S314). The determination unit 323 transmits the determination result to the information terminal 130 (step S115). Further, when the determination unit 323 determines that the precedence pass is usable, the determination unit 323 instructs the updating unit 324 to update the effective number of times of the precedence pass associated with the parking information.

The processing unit 332 of the information terminal 330 receives, from the precedence pass management system 320, the determination result, and in response to the determination result, controls an output of the output unit 133 (step S116). Further, the processing unit 332, in response to the determination result, controls the output device 335. The information terminal 330 transmits the output result of the output device 335 to the precedence pass management system 320.

For example, when the output device 335 is the gate 331, the processing unit 332, in response to the determination result, controls opening and closing of the flapper of the gate 331. At the precedence entrance in which the information terminal 330 including the gate 331 is present, parking area users may determine whether the precedence pass is usable based on opening and closing of the flapper of the gate 331 in response to the determination result.

The updating unit 324 of the precedence pass management system 320 receives, from the information terminal 330, the output result of the output device (step S318).

The updating unit 324 receives the instruction of the data update process and the output result of the output device. The updating unit 324 reduces one time from the effective number of times of the parking information, based on which the determination is made as usable among the precedence pass data stored in the storage unit 122. The updating unit 324 stores the reduced effective number of times in the storage unit 122 and updates the effective number of times (step S319). Further, the updating unit 324 stores the output result associated with the precedence pass to the storage unit 122 (step S320).

### Effect of Third Example Embodiment

According to the third example embodiment, the precedence pass management system 320 can control the output device 335 of the information terminal 330 in response to the determination result. Accordingly, it is not necessary to arrange employees of the facility at the gate 311 for the precedence entrance of the stadium.

Further, according to the third example embodiment, the updating unit 324 of the precedence pass management system 320 receives the output result from the output device of the information terminal 330 and thereafter starts the update process, and accordingly, the management accuracy of the effective number of times of the precedence pass can be enhanced.

### Another Example Embodiments

As similar to the first example embodiment, provided in another example embodiment is a precedence pass management system that is communicable with a parking terminal present in the parking area outside the congested area and an information terminal present in the facility within the congested area. In another example embodiment, the face recognition is used to determine whether the precedence pass is usable.

The precedence pass management system includes an issuing unit and a determination unit. The issuing unit receives, from the parking terminal, parking information including identification information of a person who parks, a time when the person parks, and identification information of the parking area in which the parking terminal is provided. The identification information of the person who parks is a face image of a user who parks a vehicle in the parking area. For example, the face image is captured by a camera of the parking terminal and is transmitted from the parking terminal.

The issuing unit extracts, from the received face image, the feature point of the face. The issuing unit, based on the parking information, issues the precedence pass which can be used in the facility and associates the precedence pass with the parking information to be stored in the storage unit.

The determination unit receives, from the information terminal, the use request of the precedence pass including identification information of a customer who uses the precedence pass in the facility and a time thereof. A customer who uses the precedence pass in the facility is, for example, a user of the parking area outside the congested area. Further, the identification information is the face image of the customer. The use request including the identification image of the customer and the time is transmitted, via the information terminal, to the precedence pass management system.

The determination unit extracts, from the face image of the identification information included in the use request, the feature point of the face of the customer. The determination unit compares the identification information and the time included in the parking information stored by the storage unit with the identification information and the time included in the received precedence pass use request to determine whether the received use request is an allowable request. The comparison between pieces of identification information can be conducted through the face recognition technology. The determination unit transmits the determination result to the information terminal.

The information terminal receives the determination result and, in response to the determination result, controls the output unit of the information terminal.

When the determination result indicates that the precedence pass use request is allowable, the information terminal controls the output unit of the information terminal in such a way that a customer who uses the precedence pass can enjoy the service in preference to other customers. For example, when the output unit is the display, the information terminal controls the display in such a way that “o” is displayed on the display.

When the determination result indicates that the precedence pass use request is not allowable, the information terminal controls the output unit of the information terminal to output information indicating that the precedence pass use request is not allowable. For example, when the output unit is the display, the information terminal controls the display to display “x” on the display.

As above, the disclosed subject matter has been described by taking above described example embodiments as exemplary examples. However, the disclosed subject matter is not limited to the above described example embodiments. In other words, to the disclosed subject matter, various aspects that could be understood by a person skilled in the art within a scope of the disclosed subject matter can be applied.

Hardware Configuration

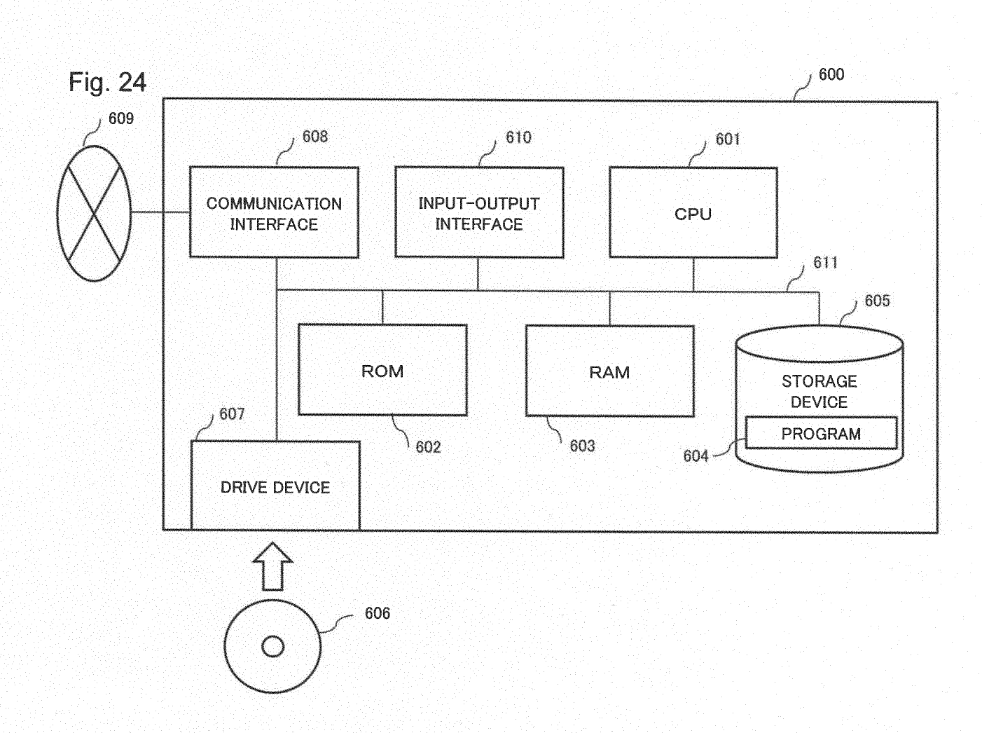

FIG. 24 is a drawing illustrating a hardware configuration for realizing, with a computer, the parking terminal, the precedence pass management system, and the information terminal of the first to third example embodiments and the user terminal of the second and third example embodiments.

Respective components of the parking terminal, the precedence pass management system, and the information terminal of the first to third example embodiments and the user terminal of the second and third example embodiments represent blocks of function units. A part or a whole of the respective components of the parking terminal, the precedence pass management system, the information terminal, and the user terminal is realized by, for example, any combination of a computer 600 and a program as illustrated in FIG. 24. As an example, the computer 600 includes the following configurations.
a CPU (Central Processing Unit) 601,
an ROM (Read Only Memory) 602,
an RAM (Random Access Memory) 603,
a program 604 loaded to the RAM 603,
a storage device 605 that stores the program 604,
a drive device 607 for reading/writing from/to a storage medium 606,
a communication interface 608 coupled with a communication network 609,
an input-output interface 610 for input/output of data,
a bus 611 for connecting each component

A CPU 601 that acquires the program 604 for implementing functions of the components and executes the program realizes respective components of the parking terminal, the precedence pass management system, the information terminal, and the user terminal. The program 604 that realizes the functions of the respective components is, for example, stored in the storage device 605 or the RAM 603 in advance, and the CPU 601 reads the program as needed. Note that the program 604 may be supplied, via the communication network 609, to the CPU 601 or the program may be stored in the storage medium 606 in advance and the drive device 607 may read the program and supply the program to the CPU 601.

A method for realizing the precedence pass management system and the like includes various modifications. For example, each component of the precedence pass management system 120 may be realized by a separate and arbitrary combination of the computer 600 and the program. Alternatively, a plurality of components of the precedence pass management system 120 may be realized by any combination of a single computer 600 and the program.

For example, a part or a whole of the respective components of the precedence pass management system 120 is realized by other general-purpose circuits or dedicated circuits, or processors or a combination thereof. The circuits and the processors may be configured by a single chip or configured from a plurality of chips coupled via the bus. Further, instead of the computer 600, a programmable logic device such as Field-Programmable Gate Array (FPGA) may be used.

A part or a whole of each component of the precedence pass management system 120 may be realized by a combination of the above described circuits and the like and the program.

When a part or a whole of each component of the precedence pass management system 120 is realized by a plurality of computers, circuits, or the like, the plurality of computers, the circuits or the like may be arranged in a centralized manner or may be arranged in a decentralized manner. For example, the computers, the circuits or the like may be realized as a form such as a client and server system and a cloud computing system in which each component is coupled via the communication network.

As above, the disclosed subject matter has been described by referring to the example embodiments, but the disclosed subject matter is not limited to the above described example embodiments. Various modifications that could be understood by a person skilled in the art within the scope of the disclosed subject matter can be made to configurations and details of the disclosed subject matter.

### REFERENCE SIGNS LIST

10 Parking area
11 Parking space
12 Passage gate
13 Vehicle
100,200,300 Park & Ride system
110,210 Parking terminal
111 Receiving unit
112 Parking information generating unit
115 Parking ticket
116 Two-dimensional code
120,320 Precedence pass management system
121 Issuing unit
122 Storage unit
123,323 Determination unit
124,324 Updating unit
130,330 Information terminal
131 Acquisition unit
132,332 Processing unit
133 Output unit
240 User terminal
241 Acquisition unit
242 Processing unit
335 Output device
601 CPU
602 ROM (Read Only Memory)
603 RAM
604 Program
605 Storage device
606 Storage medium
607 Drive device
608 Communication interface
609 Communication network
610 Input-output interface
611 Bus
PA, PB Parking area
TFX,TFY,TFZ Sightseeing facility

1. A precedence pass management system that is communicable with a user terminal and an information terminal that presents in a facility within a congested area, the precedence pass management system comprising:
an issuing unit; and
a determination unit,
wherein the user terminal acquires parking information indicating a use of a parking area outside the congested area and transmits the parking information to the precedence pass management system,
wherein the issuing unit
receives the parking information from the user terminal,
issues a precedence pass for prioritizing an order of a user of the parking area to a queue in the facility, based on the parking information, and
associates the precedence pass with the parking information to be stored in storage,
wherein the determination unit
receives a use request of the precedence pass including parking information from the information terminal,
collates the parking information stored in the storage with the parking information included in the use request to determine whether the precedence pass is usable, and
transmits a determination result as to whether the precedence pass is usable to the information terminal, and
wherein the information terminal receives the determination result from the precedence pass management system and controls output unit of the information terminal in response to the determination result.

2. The precedence pass management system according to claim 1, wherein the parking information includes a parking area ID for identifying the parking area, a user ID for identifying a user of the parking area, and a parking date and time parked in the parking area.

3. The precedence pass management system according to claim 1, wherein the issuing unit sets, to the precedence pass, a predetermined effective number of times depending on a distance between a predetermined position within the congested area and the parking area, and stores the effective number of times to the storage.

4. The precedence pass management system according to claim 1, wherein the issuing unit sets, to the precedence pass, a predetermined expiration date depending on a distance between a predetermined position within the congested area and the parking area, and stores the expiration date to the storage.

5. The precedence pass management system according to claim 1, wherein when the received determination result indicates that the precedence pass is unusable, the information terminal controls the output unit to output information indicating that the precedence pass is unusable.

6. The precedence pass management system according to claim 1,
wherein the output unit is a sound tool, and
wherein the information terminal controls the sound tool in such a way that different sounds are sounded in response to the determination result.

7. The precedence pass management system according to claim 1,
wherein the output unit is a display, and
wherein the information terminal controls the display in such a way that different pieces of information are displayed in response to the determination result.

8. The precedence pass management system according to claim 1,
wherein the facility includes a gate for a user of the parking area who uses the precedence pass, and
wherein the information terminal controls the gate in response to the determination result.

9. The precedence pass management system according to claim 1,
wherein the facility includes a store cash register for a user of the parking area who uses the precedence pass, and
wherein the information terminal controls the store cash register, in response to the determination result.

10. The precedence pass management system according to claim 1,
wherein the determination unit associates the use request with the precedence pass to be stored in the storage.

11. The precedence pass management system according to claim 1,
wherein the information terminal includes an output device, and
wherein the precedence pass management system receives an output result of the output device from the information terminal and associates the received output result with the precedence pass to be stored in the storage.

12. The precedence pass management system according to claim 8,
wherein the information terminal includes an output device, and
wherein the precedence pass management system receives an output result of the output device , from the information terminal and associates the received output result with the precedence pass to be stored in the storage.

13. The precedence pass management system according to claim 1,
wherein when the determination unit determines that the precedence pass can be used relative to the received use request, the determination unit updates effective number of times of the precedence pass stored by the storage.

14. The precedence pass management system according to claim 1,
wherein a parking terminal present in the parking area issues a parking ticket displaying the parking information to which two-dimensional coding is conducted, and
wherein the user terminal acquires the parking information based on a two-dimensional code displayed on the parking ticket.

15. (canceled)

16. (canceled)

17. A management method for a precedence pass management system that is communicable with a user terminal and an information terminal that presents in a facility within a congested area,
wherein the user terminal receives parking information indicating a use of a parking area outside the congested area and transmits the parking information to the precedence pass management system;
wherein the precedence pass management system
receives the parking information from the user terminal to a queue in the facility,
based on the parking information, issues a precedence pass for prioritizing an order of a user of the parking area, and associates the precedence pass with the parking information to be stored in storage,
receives a use request of the precedence pass including parking information from the information terminal,
collates parking information stored in the storage with parking information included in the use request to determine whether the precedence pass is usable, and
transmits a determination result as to whether the precedence pass is usable to the information terminal; and
wherein the information terminal receives the determination result from the precedence pass management system and controls output of the information terminal in response to the determination result.

18. The management method for the precedence pass management system according to claim 17,
wherein predetermined effective number of times depending on a distance between a predetermined position within the congested area and the parking area are set to the precedence pass.

19. The management method for the precedence pass management system according to claim 17,
wherein a predetermined expiration date depending on a distance between a predetermined position within the congested area and the parking area is set to the precedence pass.

20. (canceled)

21. A non-transitory computer-readable storage medium storing a management program for a precedence pass management system that is communicable with a user terminal and an information terminal that presents in a facility within a congested area,
wherein the user terminal acquires parking information indicating a use of a parking area outside a congested area and transmits the parking information to the precedence pass management system;
the management program causes a computer to execute:
receiving, from the user terminal, the parking information;
based on the parking information, issuing a precedence pass for prioritizing an order of a user of the parking area to a queue in the facility, and associating the precedence pass with the parking information to be stored in storage;
receiving a use request of the precedence pass including parking information from the information terminal;
collating parking information stored in the storage with parking information included in the use request to determine whether the precedence pass is usable; and
transmitting a determination result as to whether the precedence pass is usable to the information terminal,
wherein the information terminal receives the determination result from the precedence pass management system and controls output unit of the information terminal in response to the determination result.

22. The storage medium storing the management program for the precedence pass management system according to claim 21,
wherein the management program causes a computer to execute setting, to the precedence pass, predetermined effective number of times depending on a distance between a predetermined position within the congested area and the parking area.

23. The storage medium storing the management program for the precedence pass management system according to claim 21,
wherein the management program causes a computer to execute setting, to the precedence pass, a predetermined expiration date depending on a distance between a predetermined position within the congested area and the parking area.
